(19) United States
(12) Patent Application Publication
(10) Pub. No.: US 2013/0038226 A1
(43) Pub. Date: Feb. 14, 2013

(54) Plasma Supply Arrangement Having Quadrature Coupler

(71) Applicant: Anton Labanc, Ehrenkirchen (DE)

(72) Inventor: Anton Labanc, Ehrenkirchen (DE)

(73) Assignee: HUETTINGER Elektronik GmbH + Co. KG, Freiburg (DE)

(21) Appl. No.: 13/609,801

(22) Filed: Sep. 11, 2012

Related U.S. Application Data
(63) Continuation of application No. PCT/EP2011/053663, filed on Mar. 11, 2011.

(30) Foreign Application Priority Data
Mar. 11, 2010 (DE) 102010002754.5

(51) Int. Cl. H05H 1/00; H01P 5/18

(52) U.S. Cl. 315/173; 333/109

(57) ABSTRACT

A plasma supply arrangement for supplying power to a plasma load has a quadrature coupler which has at least one capacitance and at least one inductivity and which is suitable for coupling together two HF power signals of the same frequency which are phase-shifted relative to each other by 90°, an HF power signal being supplied respectively at a first useful signal connection and at a second useful signal connection of the quadrature coupler as a useful signal, to form a coupled HF power which can be output as a useful signal at a third useful signal connection, at least one useful signal connection being configured for a first impedance. The quadrature coupler has a fourth useful signal connection which is configured for a second impedance which is higher than the first impedance, or has only three useful signal connections.

### CROSS REFERENCE TO RELATED APPLICATIONS

This application is a continuation of and claims priority under 35 U.S.C. §120 to PCT Application No. PCT/EP2011/053663 filed on Mar. 11, 2011, which claimed priority to German Application No. 10 2010 002 754.5, filed on Mar. 11, 2010. The contents of both of these priority applications are hereby incorporated by reference in their entirety.

### TECHNICAL FIELD

The invention relates to a plasma supply arrangement for supplying power to a plasma load.

### BACKGROUND

Industrial plasma processes are used for material processing (for example, coating or etching of surfaces) and for operating gas lasers. They are characterized by abrupt changes in impedance, in particular during ignition, during extinguishing or during arc discharges (arcs). Such changes in impedance which are typical of plasma processes result in mismatching and therefore a reflection of high-frequency power. In order to produce the high level of high-frequency power in the kilowatt range required for the plasma process, the HF power signals of a plurality of HF power sources are often coupled together.

Quadrature couplers are known in principle. With correct dimensions and correct termination of the quadrature coupler, a high-frequency signal which is supplied at a useful signal connection, for example, at the useful signal connection 3 of the quadrature coupler 50 of FIG. 1, is divided, so as to be following by a phase angle φ or preceding by a phase angle −90°±φ, between the useful signal connections 1 and 2, at which the partial high-frequency signals are consequently discharged with a phase shift of 90° relative to each other. The quadrature coupler operates similarly with signals flowing in the reverse direction, so that two high-frequency signals which are phase-shifted by 90°, have the same power, and are applied at the useful signal connections 1 and 2 are discharged so as to be superimposed on useful signal connection 3. An output signal is only applied to the useful signal connection 4 when the phase relationship or the power relationship of the supplied high-frequency signals relative to each other is not precisely complied with. In many applications, that useful signal connection is provided with a terminating resistance having the nominal value of the system impedance (often 50Ω).

It is possible to obtain relatively high total output power levels by coupling individual powers (high-frequency source signals) of two high-frequency sources with quadrature couplers. Additional increases in power result from cascading couplers. This type of connection of high-frequency sources by quadrature couplers or cascading of quadrature couplers is described, for example, in EP1701376B1.

If, in order to achieve higher power levels, a plurality of power coupling stages are intended to be cascaded, the complexity of necessary components (number of discrete components) or space for circuit boards or substrate surface-area in integrated components for constructing the quadrature coupler becomes more significant. Particularly in the last power coupling stage, where a coupler has to process the total power, the components necessary are expensive.

### SUMMARY

Plasma process power supplies and quadrature couplers can be implemented to substantially reduce the necessary complexity of components in the plasma supply arrangement, in particular in the cascaded application of power couplers.

In general, one aspect of the subject matter described in this specification can be embodied in a plasma supply arrangement of the type mentioned in the introduction, wherein a fourth useful signal connection of at least one quadrature coupler of this plasma supply arrangement is configured for a second impedance which is higher than the first impedance, or at least one quadrature coupler of this plasma supply arrangement having only three useful signal connections.

Quadrature couplers can be configured in such a manner that at least one of the useful signal connections thereof is configured for a first impedance which generally corresponds to the external circuitry, for example, the system impedance. In some of the plasma supply arrangements described herein, a fourth useful signal connection is configured for an impedance which is higher than the first impedance for at least one quadrature coupler. The internal branches of the quadrature coupler leading to this useful signal connection and the external circuitry at this useful signal connection do not then need to be configured for the entire high-frequency power. In the borderline case, the impedance for which the fourth useful signal connection is configured moves towards infinity, that is to say, the admittance becomes zero. In this case, the reactances of the internal branches which result in this useful signal connection move towards infinity and current can no longer flow, and the fourth useful signal connection therefore ceases to exist.

The at least one quadrature coupler of the plasma supply arrangement can be configured for the frequency range between 3 MHz and 30 MHz and is usually constructed from discrete reactances. The term “discrete reactances” in the context of the present invention is intended to be understood to be capacitors and inductors which can be used, for example, in the T or Π form as phase lines, the expression “discrete reactances” comprising both discrete components and reactances which are constructed on a circuit board in planar technology, and mixed forms thereof. A mixed form of an inductor could comprise, for example, a planar coil and a discrete coil soldered or bonded to a circuit board. Reactances connected in parallel or in series can be combined according to the known provisions of electrical engineering in order to simplify the general circuit. Another simplification of the circuit is possible by coupling the inductors used to form a transformer.

A known quadrature coupler comprises a transformer having two windings N₁, N₂, a transformation ratio of V=N₁/N₂=1 and a coupling of k=1, at least one inductivity L which is connected in parallel with a winding and which can also be implicitly constructed in the transformer, for example, in N₁, and two capacitors C₁, C₂, which connect the windings of the transformer to each other at both sides. The inductance of the inductor is

$$L = \frac{{Z}_{0}}{ω}$$

and, for a conventional frequency of 13.56 MHz and a system impedance of Z₀=50Ω, L=586.9 nH; the value of the two capacitors is

$${C}_{1} = {C}_{2} = \frac{1}{2 \cdot ω \cdot {Z}_{0}}$$

and, for f=ω/2Π=13.56 MHz and Z₀=50Ω, C1=C2=117.4 pF. The four connections of the transformer having described components connected at that location form the four useful signal connections of the coupler, which are configured at 50Ω for the present example.

Two high-frequency signals of the same amplitude which are phase-shifted by 90° and which are applied to the useful signal connections 1 and 2 are discharged at the useful signal connection in a superimposed manner. Useful signal connection 4 is isolated. A high-frequency signal supplied at the third useful signal connection is also divided into two partial high-frequency signals which have a phase shift of 90° relative to each other and which are discharged at the useful signal connections 1 and 2 and the fourth useful signal connection is again isolated from the supplied high-frequency signal.

The quadrature coupler can be simplified with respect to the known quadrature coupler:

Since no signal is expected at the fourth useful signal connection, the value of its characteristic impedance may be changed without the property of the quadrature coupler changing during the operation described. Instead, the capacitance of the capacitor connected to this useful signal connection (for example, C₂) may be reduced accordingly whilst, on the other hand, the other capacitance C₁ may be increased accordingly in order to obtain the effective capacitance at the other three useful signal connections. The inductance of the inductor and the transformation ratio of the transformer may be increased in accordance with the new characteristic impedance. If the inductor is produced parallel with or implicitly in the winding which is not connected to the fourth useful signal connection (for example, N₁), an increase in the transformation ratio V is sufficient because the transformed value of the inductance also increases accordingly at N₂. In this case, the new values of the components are

$$L = \frac{{Z}_{0}}{ω}$$

$${C}_{2} = \frac{1}{2 \cdot ω \cdot {Z}_{4}}$$

$${C}_{1} = \frac{1}{ω \cdot {Z}_{0}} - {C}_{2}$$

$$V = \frac{{Z}_{0}}{{Z}_{4}} ,$$

where Z₄ is the characteristic impedance of the fourth useful signal connection, that is to say, the impedance for which it is configured.

If the fourth useful signal connection is configured for a characteristic impedance of Z₄=200Ω, C₂=29.3 pF; C₁=205.4 pF; V=1:4. If the fourth useful signal connection is configured for a characteristic impedance of Z₄=500Ω, C₂=11.7 pF; C₁=223 pF; V=1:10. The coupler-internal high-frequency current via the components at the fourth useful signal connection (C₂, N₂) accordingly becomes smaller so that they can be configured for a smaller load.

Particular advantages are produced if the admittance 1/Z₄ moves towards zero, that is to say, Z₄→∞ (V→0). In this case, no current is anticipated via the coupler-internal components C₂ and N₂ so that they may be dispensed with. In order to produce the quadrature coupler, it is simply necessary to have the capacitance

$${C}_{1} = \frac{1}{ω \cdot {Z}_{0}} = C$$

and the inductance

$$L = \frac{{Z}_{0}}{ω} .$$

Therefore, the quadrature coupler may have only one capacitor and one inductor.

In such a modified quadrature coupler, the primary function thereof, that is to say, the coupling of powers which are supplied at the useful signal connection 1 and useful signal connection 2 with the correct phase shift in order to be output at the useful signal connection 3, is maintained.

Such a quadrature coupler can advantageously be constructed if at least one of its inductors comprises a planar coil, that is to say, is at least partially constructed by a planar coil which can be produced without complex winding. This may be brought about, for example, by a printed conductor on a circuit board. For such planar coils, there are industrial production processes which have been found to be advantageous. A ferrite core or a similar magnetic field amplification element may be associated with the inductor in order to reduce the necessary conductor length or number of windings which would be necessary for the frequency range of the application. As a result, the electrical losses can also be reduced.

It is also advantageous if at least one capacitor of the quadrature coupler comprises a planar structure which can also be constructed on a preferably multiple-layer circuit board. A capacitor of the quadrature coupler may therefore be in the form of a planar structure or a part-capacitor may be produced by a planar structure.

The common construction or arrangement of planar structures for a capacitor and an inductor on at least one common circuit board involves another optimization because, as a result, the production costs can be further reduced.

If V=0 and therefore the useful signal connection 4 is superfluous, the complete quadrature coupler can be constructed and readily produced in an industrial manner with plane-parallel faces for the capacitance and a coil for the inductivity on a single, at least double-layer circuit board.

An embodiment having a high-frequency transformer having a bifilar winding whose connections are connected at each side by capacitors is also possible.

As long as the high-frequency powers which are supplied at the useful signal connection 1 and the useful signal connection 2 of the at least one quadrature coupler of the plasma supply arrangement according to the invention are equal, the reactances of the inductor X_{L}=L×ω or the capacitor X_{C}=−1/(ω×C) are preferably also equal in terms of value. However, if different power levels are intended to be coupled together, this is possible in the case V=0 by simply adapting the reactances. The reactance of the capacitor can be adapted at the ratio of the root of the power ratio P_{L} (high-frequency source at the useful signal connection which is connected to L internally within the coupler=P₂) and P_{C} (high-frequency source at the useful signal connection which is connected to C internally within the coupler=P₁):

$${X}_{C} = - {Z}_{0} \sqrt{\frac{{P}_{L}}{{P}_{C}}} = - {Z}_{0} \sqrt{\frac{{P}_{2}}{{P}_{1}}}$$

The reactance of the inductor between the useful signal connection 2 and the useful signal connection 3 may be adapted at the ratio of the root of the power ratio P_{C} and P_{L}:

$${X}_{L} = {Z}_{0} \sqrt{\frac{{P}_{C}}{{P}_{L}}} = {Z}_{0} \sqrt{\frac{{P}_{1}}{{P}_{2}}}$$

The higher the power proportion of a high-frequency source at a useful signal connection, the smaller the reactance has to be between that useful signal connection and the useful signal connection 3.

The phase shifts of the high-frequency signals supplied to the output signal with the output power P₃ are

$${ϕ}_{1} = arccos \sqrt{\frac{{P}_{1}}{{P}_{3}}}$$

$${ϕ}_{2} = arccos \sqrt{\frac{{P}_{2}}{{P}_{3}}}$$

An optimum power coupling is brought about if a high-frequency source adapted to the impedance of the useful signal connection is connected to the useful signal connections 1 and 2 of the quadrature coupler, respectively; the coupled power is then available at the useful signal connection 3.

The arrangement of two high-frequency sources, for example, two inverters, together with a conventional quadrature coupler having the same nominal impedance at the four useful signal connections thereof (V=1), at which a terminating resistor is connected to the useful signal connection 4, can be taken per se to be a high-frequency source which is weakly reflective and adapted in terms of impedance. Two such high-frequency sources which are weakly reflective and adapted in terms of impedance can then be connected to useful signal connection 1 or 2 of a quadrature coupler with V<1 or V→0.

In order to obtain higher power levels, power coupling stages having quadrature couplers can be cascaded with V<1 or V→0. That is particularly advantageous in the case of the higher high-frequency power levels present in the other power coupling stages because the simpler structures save expensive components and valuable space.

Consequently, it is possible to produce a plasma supply arrangement according to the invention which has a plurality of high-frequency sources which produce a high-frequency power of >500 W at a frequency in the range from 3 MHz to 30 MHz and which further has a power coupler arrangement which is divided between a plurality of power coupling stages in a cascade-like manner. The high-frequency sources should either be adapted in terms of impedance or themselves comprise two other high-frequency sources whose power is coupled by a known quadrature coupler which is configured at all the useful signal connections for the same impedance and is connected to a terminating resistor at one useful signal connection.

In general, one aspect of the subject matter described in this specification can be embodied in a quadrature coupler which has at least one capacitor and at least one inductor and which is suitable for coupling together two HF power signals of the same frequency which are phase-shifted by 90° relative to each other, an HF power signal each being supplied at a first useful signal connection and at a second useful signal connection of the quadrature coupler as a useful signal, to form a coupled HF power which can be output as a useful signal at a third useful signal connection, at least one useful signal connection being configured for a first impedance. The at least one quadrature coupler has a fourth useful signal connection which is configured for a second impedance which is higher than the first impedance. Alternatively, the at least one quadrature coupler has only three useful signal connections.

The quadrature coupler can be constructed on a single circuit board. A compact structure thereby results using a small number of components. It is possible to ensure a high level of reproducibility owing to the construction of a quadrature coupler on a single circuit board. Furthermore, the production costs are kept low.

The circuit board can be a multiple-layer circuit board. It is thereby possible to have an even more compact construction of the quadrature coupler.

Low costs may be incurred if the circuit board is a double-sided circuit board. This means that structures can be constructed on the upper side and lower side of the circuit board.

In some implementations, there may be provision for the at least one capacitor and/or at least one inductor to be formed using planar technology. Such a quadrature coupler is also distinguished by a compact construction. Only a small number of components have to be used. Such a quadrature coupler may be produced with a high level of precise reproducibility. The production costs can be kept low.

These advantages may also be achieved in that the dimensions of the quadrature coupler are smaller than a fifth of the wavelength of the frequency of the HF power signals.

Furthermore, the scope of the invention includes a cascade of quadrature couplers according to the invention. The cascade may have at least one quadrature coupler which can be operated with the maximum coupled HF power which can be output as a useful signal. In that manner, a stabilising resistance, which would otherwise have to be configured for particularly high power levels, can be saved. A substantial cost saving thereby results.

Other advantages and features of the invention will be appreciated from the following description of embodiments with reference to the Figures of the drawings which show inventively significant details and from the claims. The individual features may each be carried out individually or carried out together in any combination in variations of the invention.

### DESCRIPTION OF DRAWINGS

FIG. 1 is a highly schematic illustration of a use of a quadrature coupler;

FIG. 2 is a schematic illustration for explaining the operation of a quadrature coupler;

FIG. 3 is an illustration of a known quadrature coupler which is constructed with discrete reactances;

FIG. 4 is an illustration of a quadrature coupler in which two capacitors have been combined;

FIG. 5 is an illustration of a quadrature coupler;

FIG. 6 is a vector diagram for explaining the operation of the quadrature coupler with HF power signals of different strengths;

FIG. 7 shows a plasma supply arrangement having a plurality of power coupling stages;

FIG. 8 shows another construction of a plasma supply arrangement;

FIG. 9 shows a possible construction of a quadrature coupler having three useful signal connections.

### DETAILED DESCRIPTION

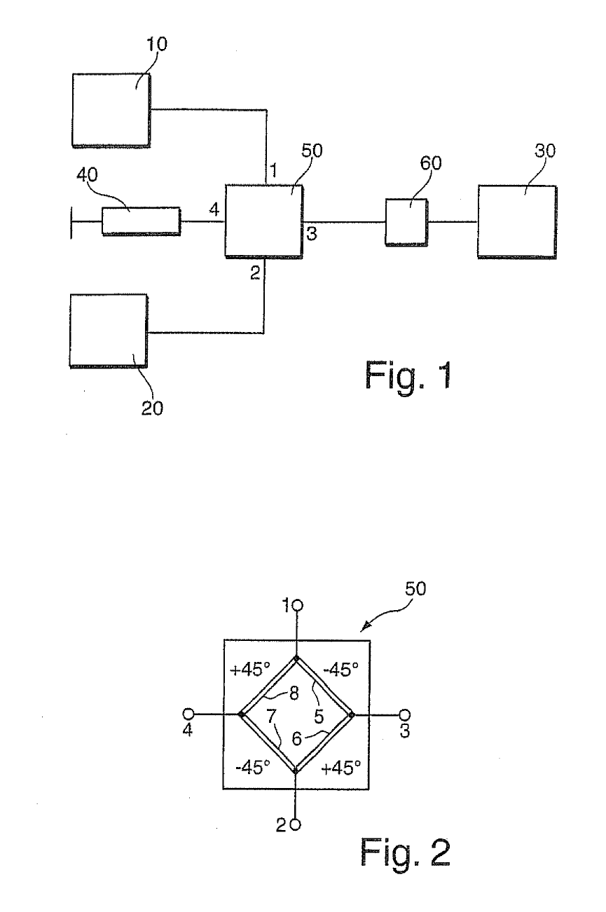

FIG. 1 shows by way of example a quadrature coupler 50 having four useful signal connections 1, 2, 3, 4. A high-frequency source 10, 20 is connected to the useful signal connections 1, 2, respectively. If the high-frequency source signals of the high-frequency sources 10, 20 have a phase-shift of 90°, they interfere constructively at the useful signal connection 3 and neutralise each other at the useful signal connection 4. Consequently, the total of the two individual powers is present at the useful signal connection 3 for consumption in the sink 30. The sink 30 may be a plasma load, for example, a plasma chamber or a gas laser. An impedance matching circuit 60 may be arranged between the useful signal connection 3 and the sink 30.

If the phase shift of the high-frequency source signals is −90°, the high-frequency source signals interfere constructively at the useful signal connection 4 and neutralise each other at the useful signal connection 3.

Since the quadrature coupler 50 is a reciprocal component, high-frequency power which returns from the sink 30, for example, a plasma chamber, because it is reflected there because of mismatching, is divided between the two useful signal connections 1 and 2. Those two signals are in quadrature relative to each other (90° phase shift). At first, no signal arrives at the useful signal connection 4 to which the terminating resistor 40 is connected. The reflected and divided signals travel to the high-frequency sources 10, 20 where they are reflected again. They then travel back to the useful signal connections 1 and 2. However, the phase angle has changed owing to the reflection at the HF sources 10, 20 so that the signals interfere constructively at the useful signal connection 4 and consequently are directed into the terminating resistor 40. The reflected power is thereby prevented from being directed back to the sink 30 again.

The operation of the quadrature coupler 50 is intended to be explained with reference to FIG. 2. In order to obtain a phase shift of 90°, a signal from the useful signal connection 1 to the useful signal connection 3 may be delayed in the phase by 45°, and may precede from the useful signal connection 1 to the useful signal connection 4 in the phase by 45°. The same applies to the opposing useful signal connection pairs. For the phase lines 5-8, for example, reactances in the T or Π arrangement may be used. In the simplest construction, the two branches having +45° phase shift are each produced by an inductor and the two branches having −45° phase shift are each produced by a capacitance. In this instance, therefore, the quadrature coupler has two inductors and two capacitors.

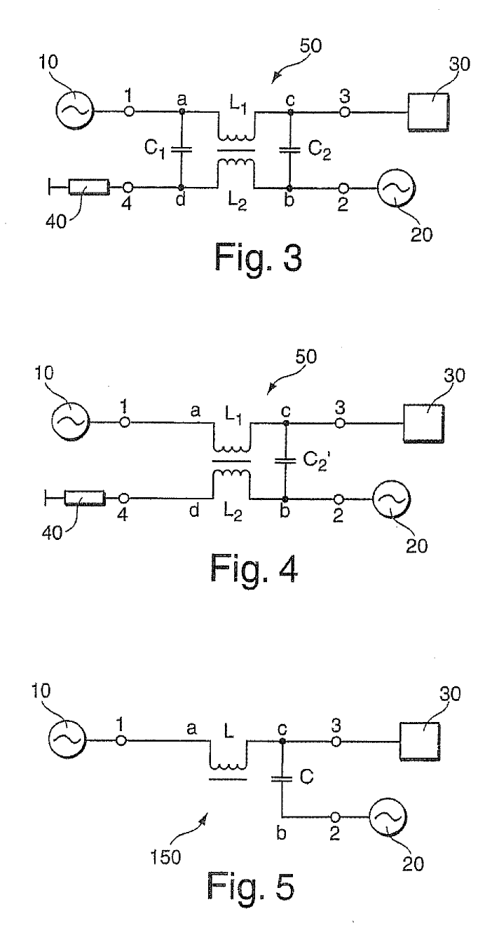

FIG. 3 shows a construction of a quadrature coupler 50 having discrete reactances for the frequency range between 3 MHz and 30 MHz. The phase lines 5 to 8 between the four useful signal connections 1 to 4 are combined in two capacitors C₁, C₂ and two coupled inductors L₁, L₂. With a coupling of K=1 between the two inductors L₁, L₂, the voltage between the points a and c is equal to that between the points d and b, and the voltage V_{ad} between the points a and d is equal to the voltage V_{bc} between the points c and b.

The necessary impedance values are

$${C}_{1} = {C}_{2} = \frac{1}{2 ω {Z}_{0}}$$

$${L}_{1} = {L}_{2} = ω {Z}_{0}$$

$$K = 1$$

where Z₀ is the system impedance (often 50Ω) and K is the coupling factor between L₁ and L₂.

Since in the mentioned prerequisites at any time V_{ad}=V_{bc}, the two capacitors C₁ and C₂ of the quadrature coupler 50 constructed as a quadrature coupler may be combined to form a single capacitor C₂′ having double the capacitance value

$$( \frac{1}{ω {Z}_{0}} ) ,$$

### see FIG. 4.

If both high-frequency sources 10, 20 are adapted and operate with the correct phase shift, the complete coupled high-frequency power is available at the useful signal connection 3. A signal reflected from there in the event of mismatching of the load 30 is uniformly distributed by the quadrature coupler 150 among the useful signal connections 1 and 2 so that the reflection also does not cause any signal at the useful signal connection 4 as long as the two high-frequency sources 10, 20 at which the reflected part-powers arrive are matched in terms of impedance. Under that condition, therefore, the complete branch with the useful signal connection 4 and the terminating resistor 40 can be removed. That form of the quadrature coupler according to the invention with V=0 only requires half of the components or a substantially reduced space on the circuit board, as can be seen in FIG. 5. The reactance of the inductor is then

$${X}_{L} = {Z}_{0} \sqrt{\frac{{P}_{1}}{{P}_{2}}}$$

and the reactance of the capacitor C is then

$${X}_{C} = - {Z}_{0} \sqrt{\frac{{P}_{2}}{{P}_{1}}} .$$

At the same power levels P₁, P₂ of the high-frequency sources 10, 20, consequently, X_{L}=Z₀ and X_{C}=−Z₀.

The capacitors(s) may be constructed as planar capacitors on a circuit board and the inductor(s) may be constructed as printed conductors on a circuit board, ferrites or other materials amplifying a magnetic field being able to amplify the inductance and coupling of the printed conductors.

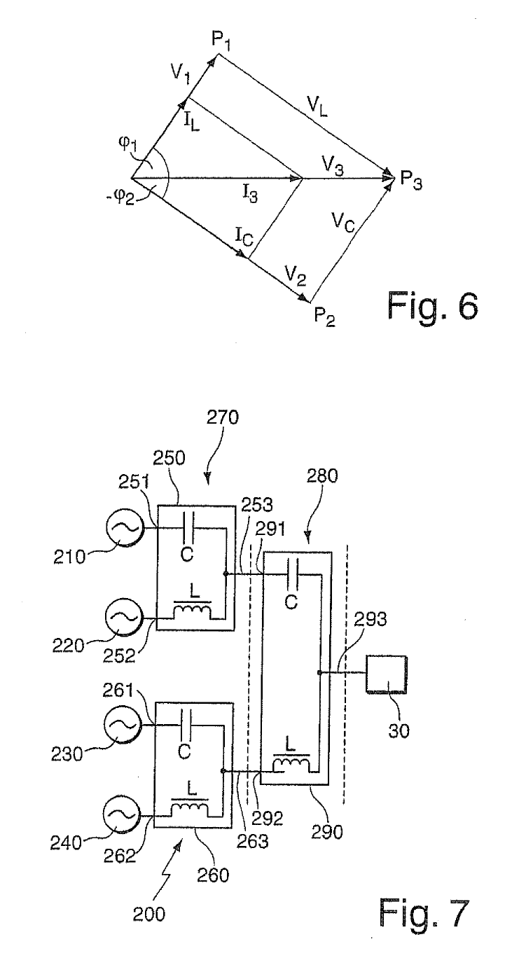

The operation of a quadrature coupler 150 is explained with reference to FIG. 6; it is configured for HF power signals of different strengths. FIG. 6 is a vector diagram of the input powers P₁, P₂ and the output power P₃. The phase of the output power P₃ is 0°. However, the input power P₁ precedes by Ω₁ and P₂ follows by −φ₂, where |(φ₁|; |φ₂|≠45°. V₁, V₂ are the voltages at the useful signal connections 1 and 2 and I_{L}, I_{C} are the currents through L and C, respectively.

If the high-frequency powers supplied at the useful signal connection 1 and useful signal connection 2 of a quadrature coupler 150 according to the invention with V=0 are not equal, the reactances of the inductor L or the capacitor C also have to be adapted. The reactances must be adapted at the ratio of the root of the power ratio P₁=V₁×I_{L} (high-frequency source 10 at useful signal connection 1) and P₂=V₂×I_{C} (high-frequency source 20 at useful signal connection 2), the reactance of the capacitor C between the useful signal connection 1 and the useful signal connection 3 being

$${X}_{C} = - {Z}_{0} \sqrt{\frac{{P}_{2}}{{P}_{1}}}$$

and the reactance of the inductor between the useful signal connection 2 and the useful signal connection 3 being

$${X}_{L} = {Z}_{0} \sqrt{\frac{{P}_{1}}{{P}_{2}}} .$$

The phase shift between the two HF power signals P₁, P₂ which are supplied at the useful signal connections 1 and 2 is further 90° whilst the phase relationship of those two HF power signals to the output signal at the useful signal connection 3 of the quadrature coupler is no longer necessarily +45° but is instead dependent on the power ratio.

FIG. 7 shows a plasma supply arrangement 200 which has four high-frequency sources 210, 220, 230, 240. The high-frequency sources 210, 220 are connected to a first quadrature coupler 250 which has three useful signal connections 251, 252, 253. The high-frequency power signals supplied by the high-frequency sources 210, 220 are phase-shifted by 90° and are coupled by the quadrature coupler 250 to form a high-frequency power signal which is twice as large and which applies at the useful signal connection 253. The high-frequency sources 230, 240 are connected to a quadrature coupler 260 which has three useful signal connections 261, 262, 263. The high-frequency power signals output by the high-frequency sources 230, 240 are also phase-shifted by 90° so that they are coupled in the quadrature coupler 260 to form a high-frequency power signal which is twice as large and which applies at the useful signal connection 263.

The quadrature couplers 250, 260 are arranged in a first power coupling stage 270. A quadrature coupler 290 which has three useful signal connections 291, 292, 293 is again arranged in a second power coupling stage 280. The output signals of the quadrature coupler 250, 260 are also phase-shifted by 90° and are supplied to the useful signal connections 291, 292 of the quadrature coupler 290. Consequently, those signals are coupled by the quadrature coupler 290 to form a high-frequency power signal which applies at the useful signal connection 293 and is supplied to a plasma load 30. All the quadrature couplers 250, 260, 290 of the embodiment shown in FIG. 7 have only two discrete reactances, that is to say, a capacitor C and an inductor L.

If it is assumed that each high-frequency source 210, 220, 230, 240 outputs a high-frequency power P, a power 2×P is present at each of the useful signal connections 253, 263 and a power 4×P at the useful signal connection 293.

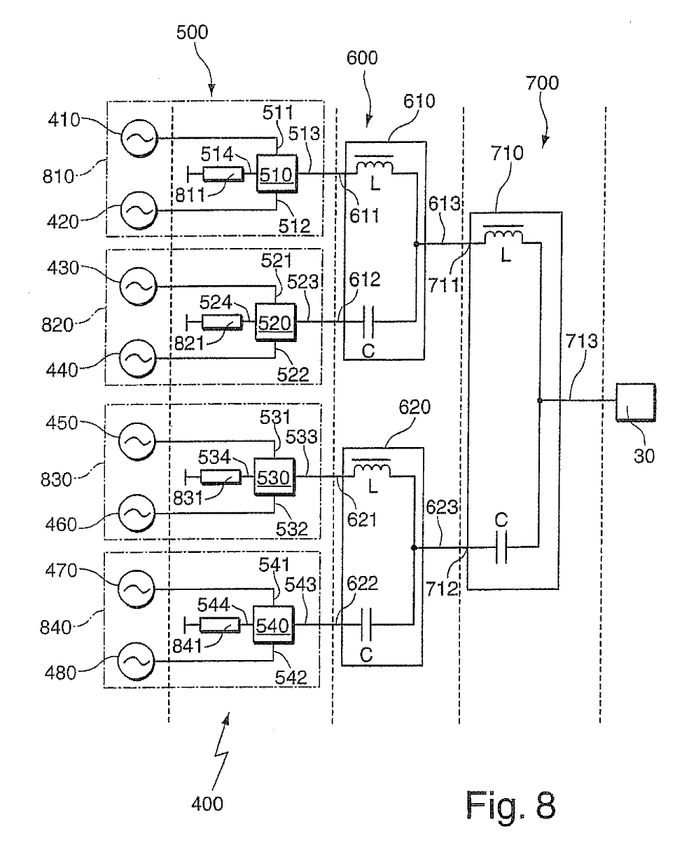

Another embodiment of a plasma supply arrangement 400 is shown in FIG. 8. The plasma supply arrangement 400 has eight high-frequency sources 410, 420, 430, 440, 450, 460, 470, 480. In a first power coupling stage 500 (between the first two broken lines from the left), there are only provided known quadrature couplers 510, 520, 530, 540 which each have four useful signal connections 511 to 514, 521 to 524, 531 to 534 and 541 to 544 which are all configured for the same nominal impedance. In a second power coupling stage 600, there are provided quadrature couplers 610, 620 which each have three useful signal connections 611 to 613 and 621 to 623. A quadrature coupler 710 having three useful signal connections 711 to 713 is arranged in a third power coupling stage 700. The useful signal connection 713 is connected to a plasma load 30.

Consequently, the power discharged by the high-frequency sources 410, 420, 430, 440, 450, 460, 470, 480 is coupled by the power coupling stages 500, 600, 700 and the total of the high-frequency powers is supplied to the plasma load 30. The arrangements 810, 820, 830, 840 surrounded by the broken lines can again be taken to be high-frequency sources themselves. Those high-frequency sources 810, 820, 830, 840 are constructed in such a manner that they do not reflect the reflected power again, that is to say, they have an impedance equal to the system impedance at the output thereof. To that end, the high-frequency sources 810, 820, 830, 840 themselves are again constructed from a known quadrature coupler 510, 520, 530, 540 each having four useful signal connections. A terminating resistor 811, 821, 831, 841 is connected to the fourth useful signal connection 514, 524, 534, 544. Signals which are reflected by the load 30 at the high-frequency sources 810, 820, 830, 840 and reflected once more by the additional high-frequency sources 410, 420, 430, 440, 450, 460, 470, 480 subsequently have such a phase relationship that they interfere constructively on the useful signal connections 514, 524, 534, 544 and are absorbed in the terminating resistors 811, 821, 831, 841, respectively. As a result, the high-frequency sources 810, 820, 830, 840 are reflection-free and at the outputs thereof (useful signal connections 513, 523, 533, 543) reflect the impedance of the terminating resistor 811, 821, 831, 841 which can have an impedance equal to the system impedance.

The high-frequency sources 410 to 480 may be constructed, for example, as generators, inverters, amplifiers or a coupled plurality of such units.

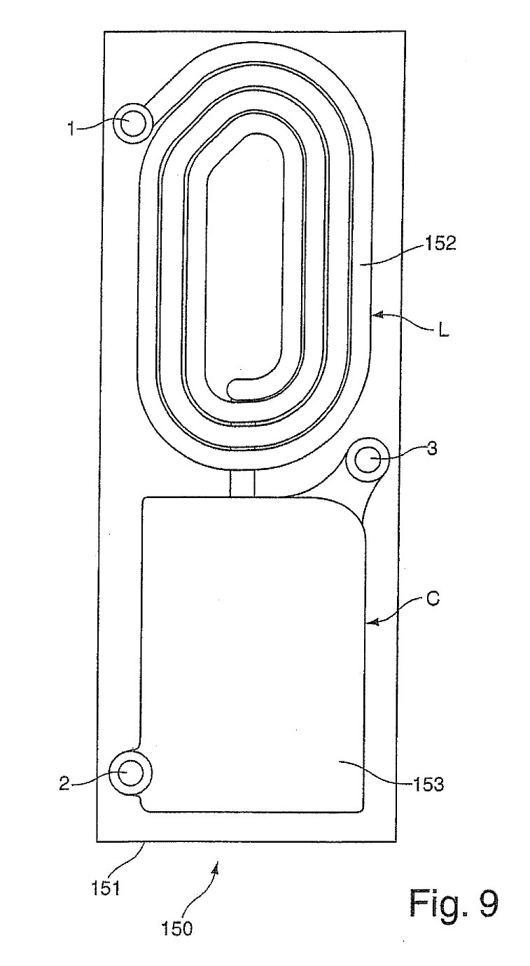

FIG. 9 is a top view of a construction of a quadrature coupler having three useful signal connections 1, 2, 3, 150, as illustrated in the circuit diagram of FIG. 5. The quadrature coupler 150 is constructed on a single circuit board 151. A coil L and a capacitor C are constructed in planar technology. The coil L has only one printed conductor 152 which is arranged in a plurality of windings. The capacitor C has parallel (conductor) surfaces, only the surface 153 being visible. A second surface is arranged therebelow and is concealed by the surface 153. The circuit board 151 is constructed so as to have two layers in order to be able to produce the second surface. The surfaces 153 are planar structures.

A number of embodiments of the invention have been described. Nevertheless, it will be understood that various modifications may be made without departing from the spirit and scope of the invention. Accordingly, other embodiments are within the scope of the following claims.

What is claimed is:

1. A plasma process power supply comprising a quadrature coupler, the quadrature coupler comprising:
a capacitor and an inductor; and
first, second, third and fourth useful signal connections;
wherein the capacitor and inductor are configured so that, when a first high frequency (HF) power signal is applied at the first useful signal connection and a second HF power signal, having a same frequency as the first HF power signal and phase shifted relative to the first HF power signal by 90°, is applied at the second useful signal connection, the quadrature coupler constructively forms a coupled HF power signal at the third useful signal connection;
wherein at least one signal connection of the first, second, and third useful signal connections has a first impedance; and
wherein the fourth useful signal connection has a second impedance that is higher than the first impedance.

2. The plasma process power supply of claim 1, wherein the second impedance is at least four times the first impedance.

3. The plasma process power supply of claim 1, wherein the second impedance is at least ten times the first impedance.

4. The plasma process power supply of claim 1, wherein the fourth useful signal connection of the quadrature coupler is configured for an admittance of approximately zero.

5. The plasma process power supply of claim 1, wherein the quadrature coupler has only one capacitor and one inductor.

6. The plasma process power supply of claim 1, wherein the inductor comprises a planar coil.

7. The plasma process power supply of claim 1, wherein the inductor comprises at least one printed conductor on a circuit board.

8. The plasma process power supply of claim 1, wherein the inductor comprises or is coupled to a magnetic field amplification element.

9. The plasma process power supply of claim 1, wherein the capacitor comprises a planar structure.

10. The plasma process power supply of claim 1, wherein the capacitor comprises a planar structure on a circuit board.

11. The plasma process power supply of claim 1, wherein the capacitor comprises a capacitive planar structure and the inductor comprises an inductive planar structure, and wherein the capacitive planar structure and the inductive planar structure are arranged on a common circuit board.

12. The plasma process power supply of claim 1, wherein the reactance of the capacitor is equal to the negative reactance of the inductor.

13. The plasma process power supply of claim 1, wherein the first useful signal connection is coupled to the inductor and the second useful signal connection is coupled to the capacitor, and wherein the reactance of the inductor is
$${X}_{L} = {Z}_{0} \sqrt{\frac{{P}_{1}}{{P}_{2}}}$$
and the reactance of the capacitor is
$${X}_{C} = - {Z}_{0} \sqrt{\frac{{P}_{2}}{{P}_{1}}} ,$$
wherein Z₀ is a system impedance, P₁ is the amplitude of the power in the second HF power signal, and P₂ is the amplitude of the power in the first HF power signal.

14. The plasma process power supply of claim 1, wherein first and second impedance-matched high-frequency sources are connected to the first and second useful signal connections.

15. The plasma process power supply of claim 14, wherein each of the first and second impedance-matched high-frequency sources comprise a respective second quadrature coupler having four signal connections, two additional high-frequency sources and a terminating resistor, two signal connections of the second quadrature couplers being connected to one of the additional high-frequency sources, the third useful signal connections of the second quadrature couplers respectively being connected to one useful signal connection of the first quadrature coupler, and the fourth useful signal connections of the second quadrature couplers being connected to the terminating resistors.

16. The plasma process power supply of claim 1, further comprising one or more additional quadrature couplers arranged in a cascaded manner with the quadrature coupler.

17. The plasma process power supply of claim 1, further comprising a plurality of high-frequency sources which each produce a high-frequency power of >500 W at a frequency in the range from 3 MHz to 30 MHz.

18. A quadrature coupler comprising:
a capacitor and an inductor; and
first, second, third and fourth useful signal connections;
wherein the capacitor and inductor are configured so that, when a first high frequency (HF) power signal is applied at the first useful signal connection and a second HF power signal, having a same frequency as the first HF power signal and phase shifted relative to the first HF power signal by 90°, is applied at the second useful signal connection, the quadrature coupler constructively forms a coupled HF power signal at the third useful signal connection;
wherein at least one useful signal connection is configured to have a first impedance; and
wherein the fourth signal connection is configured to have a second impedance that is higher than the first impedance.

19. The quadrature coupler of claim 18, wherein the quadrature coupler is constructed on a single circuit board.

20. The quadrature coupler of claim 19, wherein the circuit board is a multiple-layer circuit board.

21. The quadrature coupler of claim 20, wherein the circuit board is a double-sided circuit board.

22. The quadrature coupler of claim 18, wherein the capacitor or the inductor or both are formed using planar technology.

23. The quadrature coupler of claim 18, wherein one or more dimensions of the quadrature coupler are smaller than a fifth of the wavelength of the frequency of the HF power signals.

24. A plasma process power supply comprising a quadrature coupler, the quadrature coupler comprising:
a capacitor and an inductor; and
first, second, and third useful signal connections, wherein the quadrature coupler has only three useful signal connections;
wherein the capacitor and inductor are configured so that, when a first high frequency (HF) power signal is applied at the first useful signal connection and a second HF power signal, having a same frequency as the first HF power signal and phase shifted relative to the first HF power signal by 90°, is applied at the second useful signal connection, the quadrature coupler constructively forms a coupled HF power signal at the third useful signal connection.

25. The plasma process power supply of claim 24, wherein the capacitor comprises a capacitive planar structure and the inductor comprises an inductive planar structure, and wherein the capacitive planar structure and the inductive planar structure are arranged on a common circuit board.

26. The plasma process power supply of claim 24, wherein the reactance of the capacitor is equal to the negative reactance of the inductor.

27. The plasma process power supply of claim 24, wherein the first useful signal connection is coupled to the inductor and the second useful signal connection is coupled to the capacitor, and wherein the reactance of the inductor is
$${X}_{L} = {Z}_{0} \sqrt{\frac{{P}_{1}}{{P}_{2}}}$$
and the reactance of the capacitor is
$${X}_{C} = - {Z}_{0} \sqrt{\frac{{P}_{2}}{{P}_{1}}} ,$$
wherein Z₀ is a system impedance, P₁ is the amplitude of the power in the second HF power signal, and P₂ is the amplitude of the power in the first HF power signal.

28. A plasma process power supply comprising:
first and second high frequency (HF) power sources coupled to a first quadrature coupler;
third and fourth HF power sources coupled to a second quadrature coupler; and
a cascaded coupler comprising:
a plasma process output;
a capacitor coupled to an output of the first quadrature coupler and the plasma process output; and
an inductor coupled to an output of the second quadrature coupler and the plasma process output;
wherein the capacitor and inductor are configured so that, when a first high frequency (HF) power signal is applied at the capacitor and a second HF power signal, having a same frequency as the first HF power signal and phase shifted relative to the first HF power signal by 90°, is applied at the inductor, the cascaded coupler constructively forms a coupled HF power signal at the plasma process output.
